(19) United States
(12) Patent Application Publication
(10) Pub. No.: US 2013/0048168 A1
(43) Pub. Date: Feb. 28, 2013

(54) DYNAMIC TRACTION CLEATED TIRES

(71) Applicant: Henry J. Reedy, Cary, NC (US)

(72) Inventor: Henry J. Reedy, Cary, NC (US)

(21) Appl. No.: 13/596,001

(22) Filed: Aug. 27, 2012

Related U.S. Application Data
(60) Provisional application No. 61/527,160, filed on Aug. 25, 2011.

(51) Int. Cl. B60C 5/00

(52) U.S. Cl. 152/208

(57) ABSTRACT

A steel-cleated, all terrain tire has cleats that dynamically engage with changing road conditions, across slick ice and bridges, and while turning, breaking and accelerating on steep terrain. The tire design can provide stability and an enormous safety benefit in dangerous conditions, on demand, without the driver's intervention. The tire design can be used for military vehicles and aircraft, commercial jets, turboprop aircraft, heavy equipment, commercial diesel trucks, helicopters, law enforcement vehicles, fire and rescue vehicles, school buses, government vehicles, sport cars, and the like. The tire design include spring loaded cleats that can are spaced about and extend outward from the tire's surface. The spring load may be strong enough to permit the cleat to penetrate ice and the like, while not damaging asphalt or concrete roadways.

### CROSS-REFERENCE TO RELATED APPLICATION

This application claims the benefit of priority of U.S. provisional application No. 61/527,160, filed Aug. 25, 2011, the contents of which are herein incorporated by reference.

### BACKGROUND OF THE INVENTION

The present invention relates to cleated tires and, more particularly, to a cleated, all-terrain artic condition tire that dynamically engages cleats to changing road conditions.

Existing snow tires, all weather tires or steel belted radials have major disadvantages, limitations and lose traction in hazardous ice conditions. Drivers must wrap their tires with traction devices, steel chains, or attach metal studs to gain the required traction to continue through difficult driving conditions, such as mountainous terrains, high elevations, ice covered bridges, sleet and snow.

Existing contraptions require forecast planning, considerable labor, do not adapt to changing road conditions and are inconvenient or unreliable.

As can be seen, there is a need for an improved tire design that can provide stability and safety benefits in dangerous arctic conditions, while turning, breaking and accelerating on steep terrain, on demand, without driver intervention.

### SUMMARY OF THE INVENTION

In one aspect of the present invention, a

In another aspect of the present invention, a

These and other features, aspects and advantages of the present invention will become better understood with reference to the following drawings, description and claims.

### BRIEF DESCRIPTION OF THE DRAWINGS

FIG. 1 is a cross-sectional view of a dynamic traction cleated tire according to an exemplary embodiment of the present invention; and

FIG. 2 is a front view of the dynamic traction cleated tire as shown in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a steel-cleated, all terrain tire that has cleats that dynamically engage with changing road conditions, across slick ice and bridges, and while turning, breaking and accelerating on steep terrain. The tire design can provide stability and an enormous safety benefit in dangerous conditions, on demand, without the driver's intervention. The tire design can be used for military vehicles and aircraft, commercial jets, turboprop aircraft, heavy equipment, commercial diesel trucks, helicopters, law enforcement vehicles, fire and rescue vehicles, school buses, government vehicles, sport cars, and the like. The tire design include spring loaded cleats that can are spaced about and extend outward from the tire's surface. The spring load may be strong enough to permit the cleat to penetrate ice and the like, while not damaging asphalt or concrete roadways.

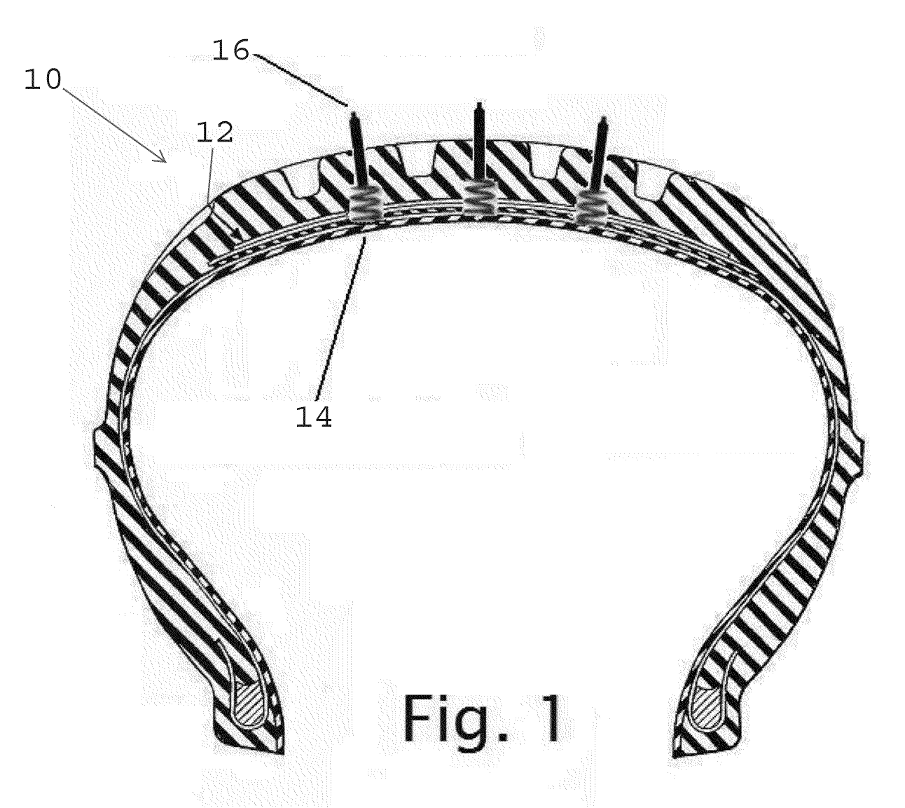

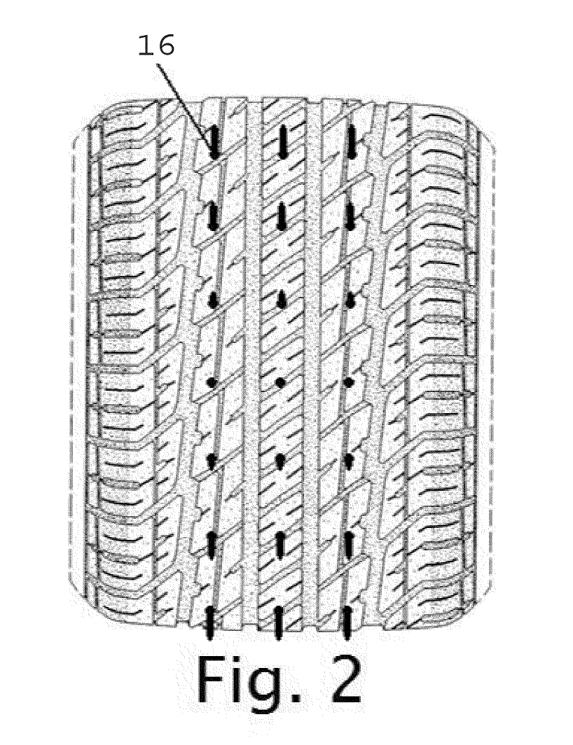

Referring now to FIGS. 1 and 2, a tire 10 can include a plurality of steel braided belts 12, as is known in the art. A plurality of load springs 14 can be disposed in the tire 10. For example, the load springs 14 can be woven or spot-welded to the steel braided belts 12 and the complete tire can be squeezed through rollers to mash all the components in place before it is sent to be vulcanized and cured.

The load springs 14 can be from about ½ to about ¾ inch long, typically about ¾ inch long. The load springs can be made from various materials, such as from austenitic steel, which is a heat-resistant alloy containing cobalt, tungsten and chromium.

Cleats 16 can be attached to the load springs 14. The cleats 16 can be made from various materials, such as tungsten-carbide, nickel-steel, titanium or any other high temperature alloy or composite material. The material strength required and the durability of each type of cleat is directly dependent on the extreme environmental conditions and specifications required by the customers and end users. Certain parts and composite materials can vary widely.

Military aircraft tires will require the highest tolerances and will comply with Military Specification (MIL-PRF-5041). Passenger jet and air cargo tires must also withstand excessive heat generated during high impact landings and high speed takeoffs. Excessive heat is generated by the high gross weight of the aircraft impacting the tarmac, high speed braking friction and high rpm takeoffs.

The length and diameter of the cleats should increase proportionally in size depending on the tire diameter, tread depth, application and overall rated utility load. For example, heave equipment and aircraft tires would require much longer and larger diameter cleats than a passenger automobile.

The total number of cleats can depend on application, user specifications or the like. Typically, a row of from about two to about four, typically about three cleats, can be disposed for each inch of tire diameter. For example, a 16-inch tire can have sixteen rows of three cleats, for a total of 48 cleats.

Each cleat 16 can extend to a present length beyond an exterior surface of the tire tread by the load spring 14 which is calibrated to the load force required to pierce through solid ice. The required calibrated force can be, for example about 70 pounds. In this example, 70 pounds of force can be exerted on the ice when the load spring is fully compressed and the cleat is just emerging outward from beneath the tire tread. As the cleat penetrates through the road ice, the force tapers off to zero pounds when the cleat is fully extended. This will not damage the much harder asphalt or concrete below the ice.

The tire design of the present invention can be integrated into existing steel belted radial fabrication processes with the addition of prefabricated, regularly spaced cleats woven into the steel braided belts.

The tire design of the present invention can potentially save lives, prevent the loss of property while in transit, prevent damage to property and prevent life threatening accidents. Owners and insurance underwriters could save significant financial losses. The tires of the present invention can be used in many different markets, such as the Antarctic, Alaska, Russia, China, Greenland, Canada, Northern Europe, Japan and the United States.

Testing can be performed to road test the tires of the present invention in both standard and military applications. The springs can be compressed at the maximum RPM to measure spring lifetime in hours. The tires should be spun against asphalt, concrete, stone and other hard surfaces at high speeds as a benchmark, then road tested where stability measurements and cleat mileage can be recorded. Paired sets of aircraft tires can be tested in Alaska, Canada and the Antarctic, utilizing, for example, the Lockheed Martin C130 turboprop cargo and the Lockheed C141 jet cargo aircraft.

It should be understood, of course, that the foregoing relates to exemplary embodiments of the invention and that modifications may be made without departing from the spirit and scope of the invention as set forth in the following claims.

What is claimed is:

1. A tire comprising:
a plurality of load springs disposed in the tire; and
a plurality of cleats disposed on the plurality of load springs.

2. The tire of claim 1, wherein the plurality of cleats are operable to resiliently depress within treads of the tire.

3. The tire of claim 1, wherein the cleats are disposed in rows about the tire, with from about 2 to about 4 cleats disposed in each row.

4. The tire of claim 3, wherein the number of rows is approximate equal to the diameter of the tire.

5. The tire of claim 1, wherein the load springs are about ¾ inch long.

6. The tire of claim 5, wherein the cleats are about are about ½ inch long.

7. The tire of claim 1, wherein the load springs are attached to a steel belt braid of the tire.

8. A tire comprising:
a plurality of load springs disposed in the tire; and
a plurality of cleats disposed on the plurality of load springs, wherein
the plurality of cleats are operable to resiliently depress within treads of the tire, and
the cleats are disposed in rows about the tire, with from about 2 to about 4 cleats disposed in each row.

9. The tire of claim 8, wherein the number of rows is approximate equal to the diameter of the tire.

10. The tire of claim 8, wherein:
the load springs are about ¾ inch long; and
the cleats are about are about ½ inch long.

11. The tire of claim 8, wherein the load springs are attached to a steel belt braid of the tire.
